(19) United States
(12) Patent Application Publication
(10) Pub. No.: US 2015/0103822 A1
(43) Pub. Date: Apr. 16, 2015

(54) NOC INTERFACE PROTOCOL ADAPTIVE TO VARIED HOST INTERFACE PROTOCOLS

(71) Applicant: NETSPEED SYSTEMS, San Jose, CA (US)

(72) Inventors: Jaya GIANCHANDANI, San Jose, CA (US); Sailesh KUMAR, San Jose, CA (US); Eric NORIGE, East Lansing, MI (US); Joe ROWLANDS, San Jose, CA (US); Rajesh CHOPRA, San Jose, CA (US)

(73) Assignee: NETSPEED SYSTEMS, San Jose, CA (US)

(21) Appl. No.: 14/054,667

(22) Filed: Oct. 15, 2013

(51) Int. Cl. H04L 29/06

(52) U.S. Cl. CPC H04L 69/08
USPC 370/389

(57) ABSTRACT

Systems and methods described herein are directed to solutions for Network on Chip (NoC) interconnects that support a variety of different component protocols each having different sets of data and/or metadata even after the NoC is designed and finalized. Example implementations include, automatically changing format of packets received from an originating SoC component by an originating bridge based on a NoC interface protocol and then transmitting the packet across the NoC interconnect to a destination bridge. The format may again be changed based on the protocol of the destination SoC component. The proposed protocol can be configured to map various transactions presented to it, be they packets belonging to the physical, data link layer, network layer or transport layer. As part of the mapping process, virtual channels for latency or deadlock avoidance may be created and may be maintained for the entire life of the packet within the NoC.

### BACKGROUND

1. Technical Field

Methods and example implementations described herein are directed to an interconnect architecture, and more specifically, to implementation of a Network on Chip (NOC) interface protocol that is adaptive to varied host interface protocols of System on Chip (SoC) Components.

2. Related Art

The number of components on a chip is rapidly growing due to increasing levels of integration, system complexity and shrinking transistor geometry. Complex System-on-Chips (SoCs) may involve a variety of components e.g., processor cores, DSPs, hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components, which are interconnected using a NoC. Terms ‘routers’ and ‘nodes’ will also be used interchangeably. Without loss of generalization, the system with multiple interconnected components will itself be referred to as a ‘multi-core system’.

There are several topologies in which the routers can connect to one another to create the system network. Bi-directional rings (as shown in FIG. 1(a)), 2-D (two dimensional) mesh (as shown in FIG. 1(b)) and 2-D Torus (as shown in FIG. 1(c)) are examples of topologies in the related art. Mesh and Torus can also be extended to 2.5-D (two and half dimensional) or 3-D (three dimensional) organizations. FIG. 1(d) shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has both ports used, one connecting to the router at the top layer and another connecting to the router at the bottom layer. Routers 110 and 112 are at the bottom and top mesh layers respectively, therefore they have only the upper facing port 113 and the lower facing port 114 respectively connected.

Packets are message transport units for intercommunication between various components. Routing involves identifying a path composed of a set of routers and physical links of the network over which packets are sent from a source to a destination. Components are connected to one or multiple ports of one or multiple routers; with each such port having a unique ID. Packets carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2(a) pictorially illustrates an example of XY routing in a two dimensional mesh. More specifically, FIG. 2(a) illustrates XY routing from node ‘34’ to node ‘00’. In the example of FIG. 2(a), each component is connected to only one port of one router. A packet is first routed over the x-axis till the packet reaches node ‘04’ where the x-coordinate of the node is the same as the x-coordinate of the destination node. The packet is next routed over the y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there may exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is the header flit, which holds information about this packet's route and key message level info along with payload data and sets up the routing behavior for all subsequent flits associated with the message. Optionally, one or more body flits follows the head flit, containing the remaining payload of data. The final flit is the tail flit, which in addition to containing the last payload also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Torus NoC, there may exist multiple route paths of equal length or number of hops between any pair of source and destination nodes. For example, in FIG. 2(b), in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3(a) illustrates a two layer NoC. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3(b), a host connected to a router from each layer, R1 and R2 respectively, is illustrated. Each router is connected to other routers in its layer using directional ports 301, and is connected to the host using injection and ejection ports 302. A bridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

In a NoC interconnect, if the traffic profile is not uniform and there is a certain amount of heterogeneity (e.g., certain hosts talking to each other more frequently than the others), the interconnect performance may depend on the NoC topology and where various hosts are placed in the topology with respect to each other and to what routers they are connected to. For example, if two hosts talk to each other frequently and require higher bandwidth than other interconnects, then they should be placed next to each other. This will reduce the latency for this communication which thereby reduces the global average latency, as well as reduce the number of router nodes and links over which the higher bandwidth of this communication must be provisioned.

Moving two hosts closer together may make certain other hosts far apart since all hosts must fit into the 2D planar NoC topology without overlapping with each other. Thus, various tradeoffs may need to be made and the hosts must be placed after examining the pair-wise bandwidth and latency requirements between all hosts so that certain global cost and performance metrics is optimized. The cost and performance metrics can be, for example, average structural latency between all communicating hosts in number of router hops, or sum of bandwidth between all pair of hosts and the distance between them in number of hops, or some combination of these two. This optimization problem is known to be Non-deterministic Polynomial-time hard (NP-hard) and heuristic based approaches are often used. The hosts in a system may vary in shape and sizes with respect to each other, which puts additional complexity in placing them in a 2D planar NoC topology, packing them optimally while leaving little whitespaces, and avoiding overlapping hosts.

There are several protocols by which components can connect to a network. Several industry standards such as Advanced eXtensible Interface (AXI), Peripheral Component Interconnect (PCI), etc are typically used for such inter-component interaction. In addition, several internal protocols have been developed for communication between components. In a complex system-on-chip, there may be over a hundred components, all of which may be connected to the same network by which they communicate with memory. These components have evolved through different periods of time and through different architectural and performance preferences, due to which they chose to adopt different interface protocols. Components that expect to connect to each other over a NoC are therefore now required to convert their communication into a language that is understood by each intended destination.

Therefore, there is a need for systems and methods for defining an efficient and multi-component compatible NoC interface protocol.

### SUMMARY

The present application is directed to designing an efficient NoC interface protocol that is adaptable to varied interface protocols of different SoC components/hosts. Aspects of the present application include a method, which may involve designing a NoC that can support a variety of different component protocols, where each protocol includes a different set of data profiles of varied sizes, formats, priorities, lengths, identifiers, among other attributes. Aspects of the present application further include supporting changes in component protocols and sizes after the NoC is designed and deployed in a SoC.

Aspects of the present application may include a method, which involves, automatically changing format of packets received from an originating SoC component by an originating bridge based on the NoC interface protocol and then transmitting the packet across the NoC interconnect to the destination bridge, at which point, the format is again changed based on the protocol of the destination SoC component.

According to one example implementation, method of the present application further comprises mapping a given traffic profile of one or more SoC hosts to the NoC interconnect and configure the NoC hardware by loading the mapping information, wherein the mapping information can include details of performing load balancing between NoC layers by automatically assigning the transactions in the traffic profile to NoC layers and balancing load on various NoC channels based on the bandwidth requirements of the transactions, and in the process also utilizing the available NoC layers and virtual channels for deadlock avoidance and isolation properties of various transactions of the traffic profile. Aspects of the present application also include conducting the above-mentioned mapping information to enable efficient/optimal and deadlock-free use of the NoC interconnect as part of the NoC interface protocol itself.

Aspect of present application may include a computer readable storage medium storing instructions for executing a process. The instructions may involve, automatically changing format of packets received from an originating SoC component by an originating bridge based on the NoC interface protocol and then transmitting the packet using the NoC interconnect to the destination bridge, at which point, the format may again be changed based on the protocol of the destination SoC component.

Aspects of present application may include a method, which involves, for a network on chip (NoC) configuration, including a plurality of cores interconnected by a plurality of routers in a heterogenous or heterogenous mesh, ring, or torus arrangement, automatically changing format of packets received from an originating SoC component by an originating bridge based on the NoC interface protocol and then transmitting the packet through the NoC interconnect to the destination bridge, at which point, the format is again changed based on the protocol of the destination SoC component.

Aspects of the present application may include a system, which involves, an originating-end protocol conversion module, a transmission module, and a destination-end protocol conversion module. The originating-end protocol conversion module may be configured to automatically change format of packets received from an originating SoC component by an originating bridge based on the NoC interface protocol. The transmission module may be configured to transmit the packet, which is broken into a plurality of flits, using the designed NoC interface protocol, to a destination bridge, at which moment, the destination-end protocol conversion module may convert the protocol of the individual flits from the NoC interface protocol to a format that is compatible to the destination SoC component.

### BRIEF DESCRIPTION OF THE DRAWINGS

FIGS. 1(a), 1(b) 1(c) and 1(d) illustrate examples of Bidirectional ring, 2D Mesh, 2D Torus, and 3D Mesh NoC Topologies.

FIG. 2(a) illustrates an example of XY routing in a related art two dimensional mesh.

FIG. 2(b) illustrates three different routes between a source and destination nodes.

FIG. 3(a) illustrates an example of a related art two layer NoC interconnect.

FIG. 3(b) illustrates the related art bridge logic between host and multiple NoC layers.

FIG. 4 illustrates processing of a packet going from an originating component to an originating bridge onward to NoC interconnect based on the proposed NoC protocol in accordance with an example implementation of the present application.

FIG. 5 illustrates processing of a packet received into a destination component from a destination bridge based on the proposed NoC protocol in accordance with an example implementation of the present application.

FIG. 6 illustrates an example implementation showing position of the proposed NoC protocol in the OSI model of computer networking in accordance with an example implementation of the present application.

FIG. 7 (a) illustrates a related art Hypertransport request packet before it is processed by the proposed NoC interface protocol in accordance with an example implementation of the present application.

FIG. 7 (b) illustrates how a pre-packetized Hypertransport request packet is re-packetized based on the proposed NoC Protocol in accordance with an example implementation of the present application.

FIG. 8 illustrates packetization of an unpacketized one-cycle custom parallel signal interface based on the proposed NoC protocol in accordance with an example implementation of the present application.

FIG. 9 (a) illustrates a related art Peripheral Component Interconnect Express (PCIE) Data Link Layer packet.

FIG. 9 (b) illustrates processing of the conventional PCIE Data Link Layer packet based on the proposed NoC Protocol in accordance with an example implementation of the present application.

FIG. 10 illustrates a flow diagram showing transportation of a packet and flits therein between components based on the proposed NoC Protocol in accordance with an example implementation of the present application.

FIG. 11 illustrates an example of computer system on which example implementations can be implemented.

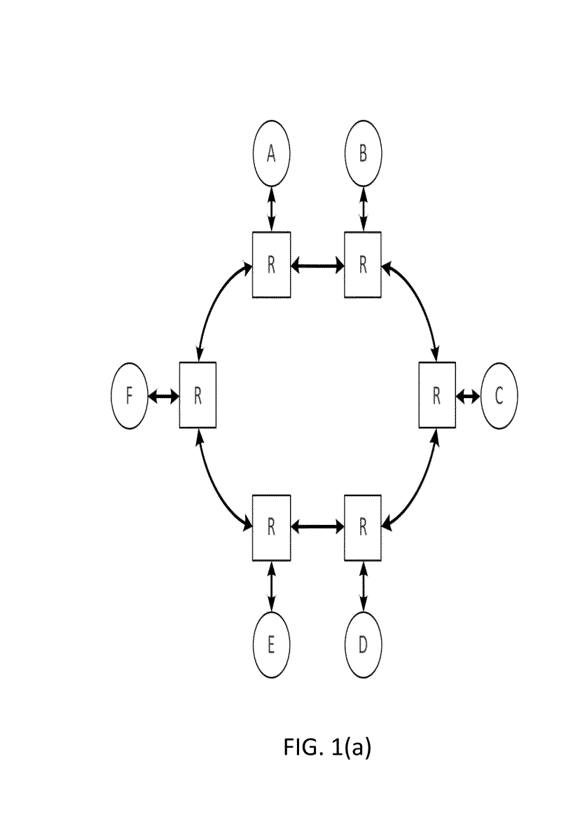

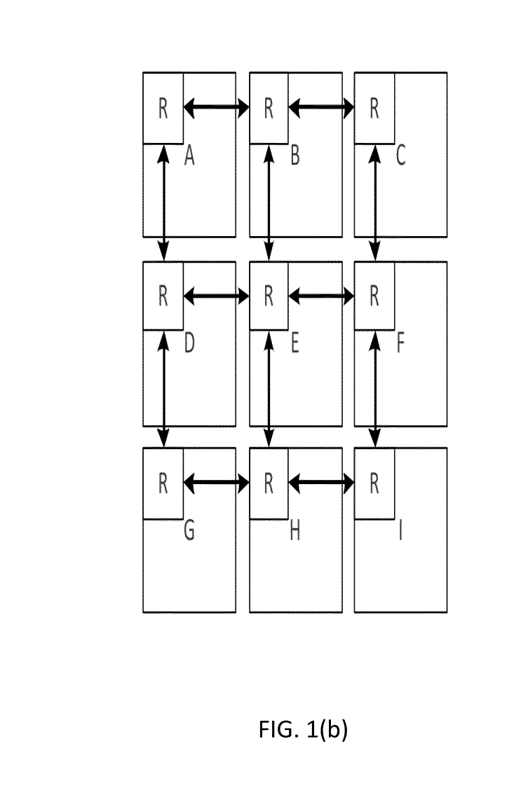

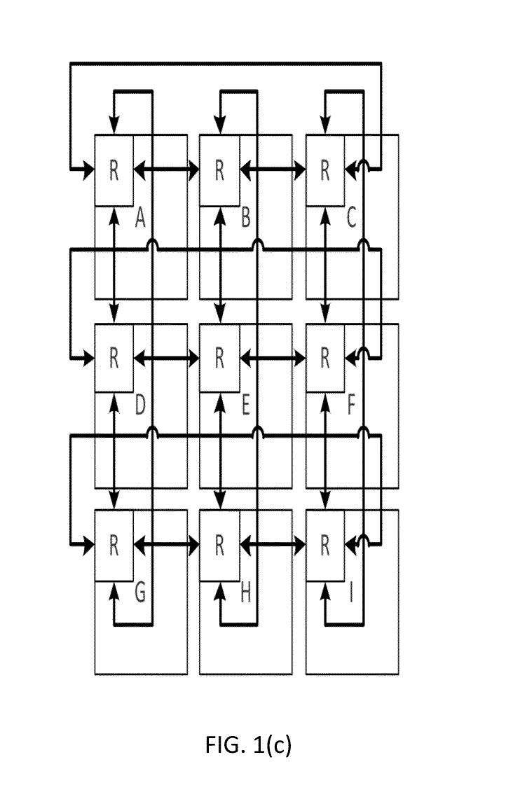

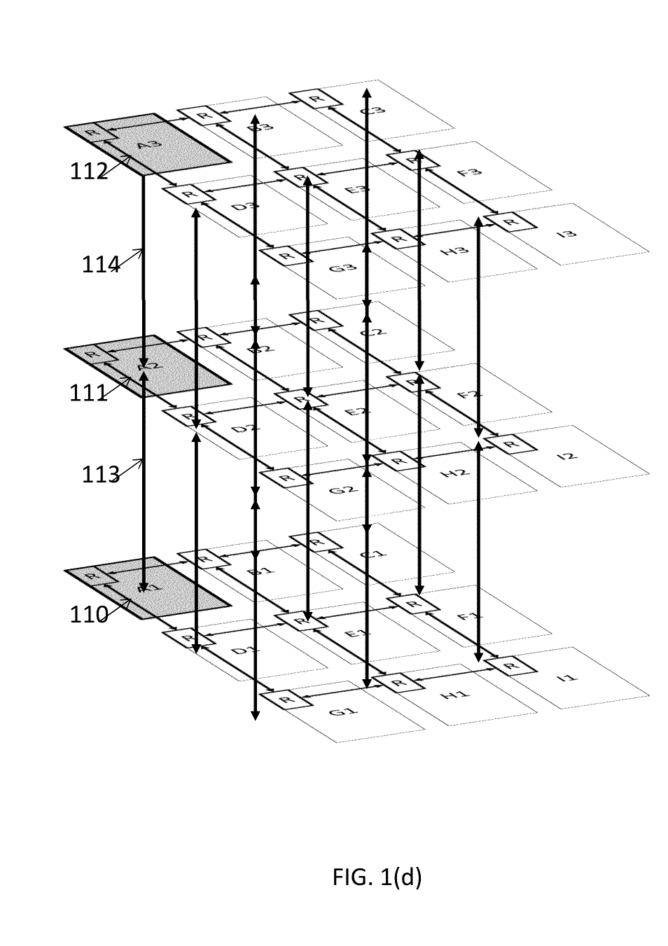

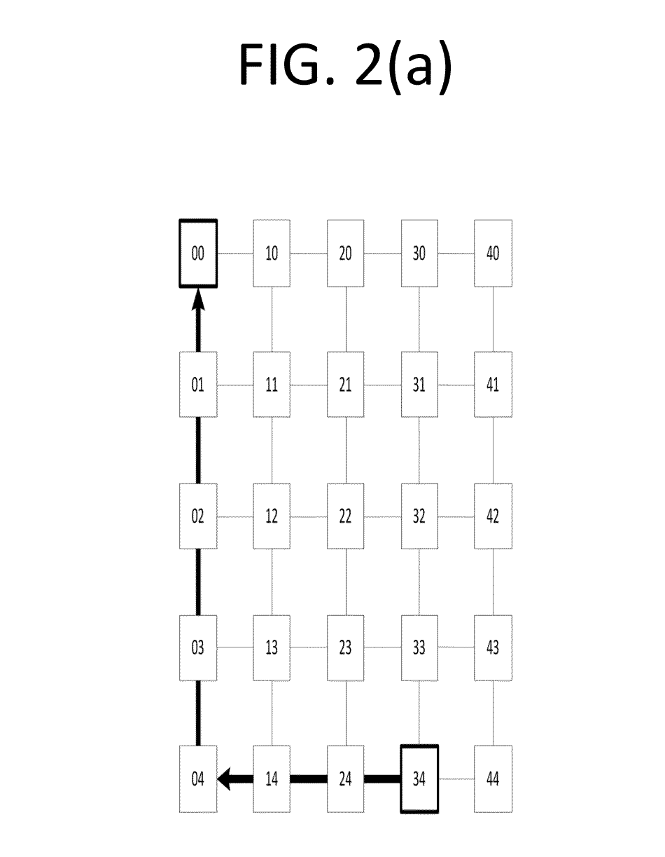

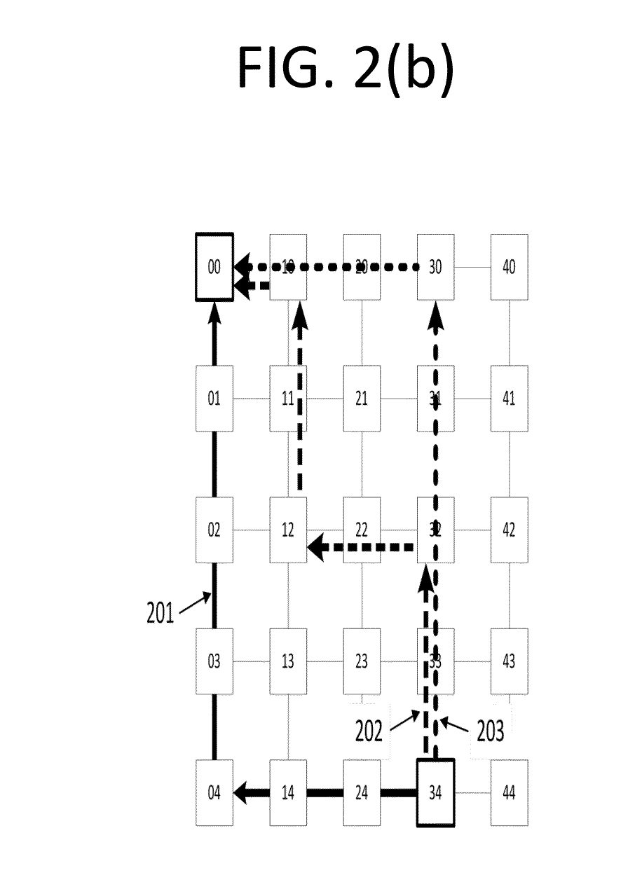

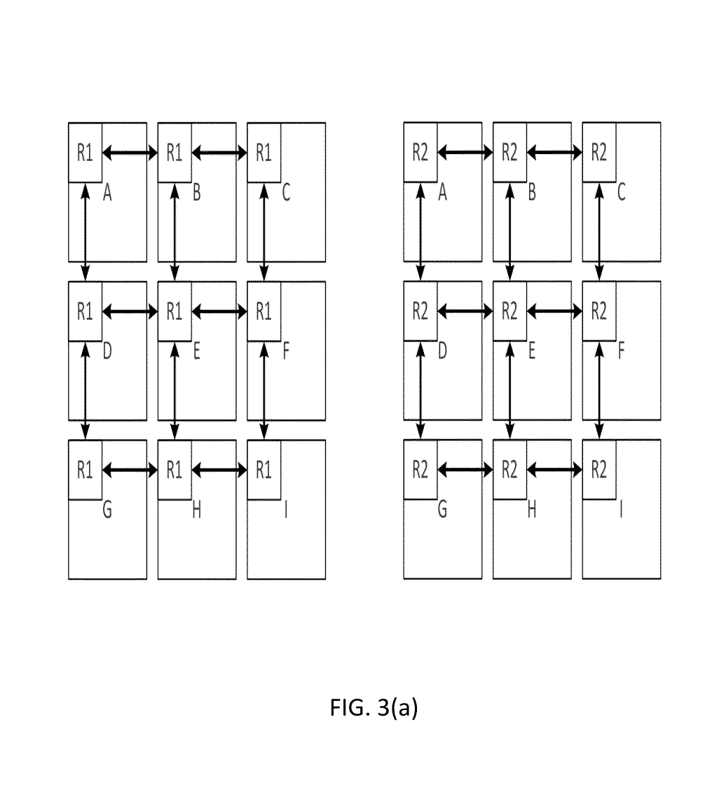

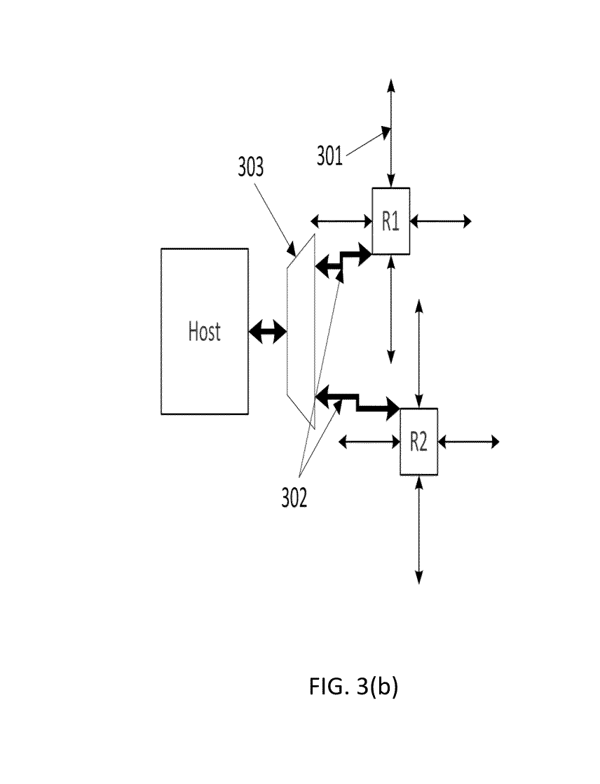

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, use of the term “automatic” may involve fully automatic or semi-automatic implementations involving user or administrator control over certain aspects of the implementation, depending on the desired implementation of one of ordinary skill in the art practicing implementations of the present application.

A distributed NoC interconnect connects various components of a system on chip (SoC) with each other using multiple routers and point to point links between the routers. Traffic profile of a SoC includes transactions between various components in the SoC and their properties (e.g., Quality of Service (QoS), priority, bandwidth and latency requirements, transaction sizes, etc.). Traffic profile information may be used to determine how various transactions will be routed in the NoC topology, and accordingly make provisions for the link capacities, virtual channels, and router nodes of the NoC. Accurate knowledge of the traffic profile can lead to a more optimized NoC hardware with minimal overprovisioning in terms of link wires, virtual channel buffers, and additional router nodes. A variety of SoCs today are designed to run a number of different applications, and the resulting NoC traffic profile therefore may differ based on how and in what market segments the SoC is deployed, and what applications are supported. Supporting a variety of traffic profiles offers several challenges in the NoC design and optimization. Even if multiple traffic profiles are supported functionally, the traffic profile observed in a particular setting may be different from the set of profiles for which the NoC is optimized, leading to sub-optimal power consumption and NoC performance.

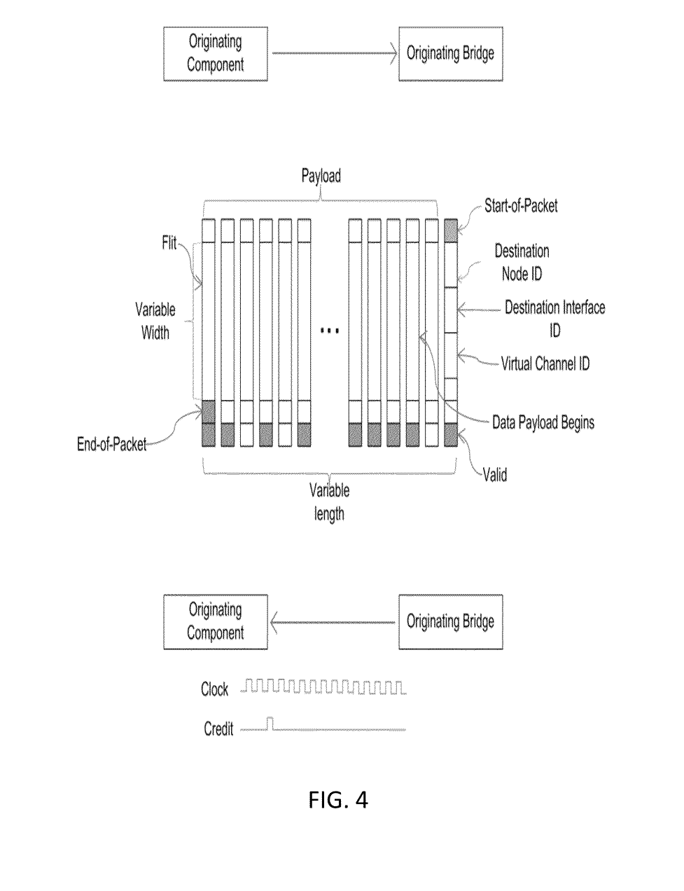

According to one example implementation, packets of any transaction from an originating host to a destination node can initially be converted in a format compatible with the NoC interconnect protocol by an originating bridge, post which the packet having the modified format can be sent through the NoC interconnect to a destination bridge, at which position, format of the packet may again be changed to make it compliant to the protocol of the destination host. FIG. 4 shows an example implementation of packet fields used in the proposed bridging protocol on the ingress side of the bridge, going from the originating component into the originating bridge. The originating bridge can also be interchangeably referred to as a transmitting bridge hereinafter. As each packet can include or be divided into one or more flits, the packet can include a head flit indicating the origin of the packet, a tail flit indicating the end of the packet, and multiple payload containing flits. As illustrated in FIG. 4, in an example implementation, the head flit can set the 1 bit indicating the start of packet (Start-of-Packet bit) and can further include an X-bit destination node identification field, a Y-bit destination interface identification field, and a Z-bit virtual channel identification field. These fields present in the head flit of a packet can allow the originating bridge and the routers of the NoC to choose which way to send the packet to its destination. In an example implementation, no data is present in the head flit. However, in another example implementation, the head flit can include payload data as well.

According to one example implementation, data payload provided by the originating component can begin in the second flit, wherein width of the data packet is variable and can be decided beforehand. Length, or the number of flits in each data packet, can also be variable and can be decided on-the-fly by the SoC component. According to another example implementation, SoC component can signal the tail flit by setting the End-of-Packet bit. According to yet another example implementation, validity of the payload data of a packet can be indicated by a valid bit, which may be present in each flit. Each packet having a “Set” valid bit can indicate that the payload in the respective flit is correct and is to be processed. In another aspect of the application, a SoC component may be configured not to provide data on each clock cycle. For example, each valid flit of a packet may be sent by a SoC component only if a credit is available with the component, wherein initial credits available to the SoC component can be set up based on FIFO depths within the bridge. In an implementation, a credit is consumed each time a component sends a valid flit, and a credit is released by the originating bridge each time a valid flit is received and processed by it. Credits can therefore be accumulated by a SoC component as they are received from the bridge.

The present protocol may give the necessary and desired simplicity and flexibility to allow any number of fields to be sent as the data payload as long as they are decoded correctly by the destination component. The protocol is lightweight and for each data or metadata flit, in an example implementation, adds only three extra bits: valid, start-of-packet, and end-of-packet. In an instance, for server systems that require strict integrity of data, a CRC or parity field may be created by a SoC component and added to one or more flits of the each packet. The destination component on receiving such a packet having CRC and/or parity fields can strip the packet into the respective fields and match CRC and/or parity accordingly. In addition, apart from above mentioned technique of First in First Out (FIFO) depth, any other mechanism can also be incorporated for generation and management of credit flow between originating component and originating bridge.

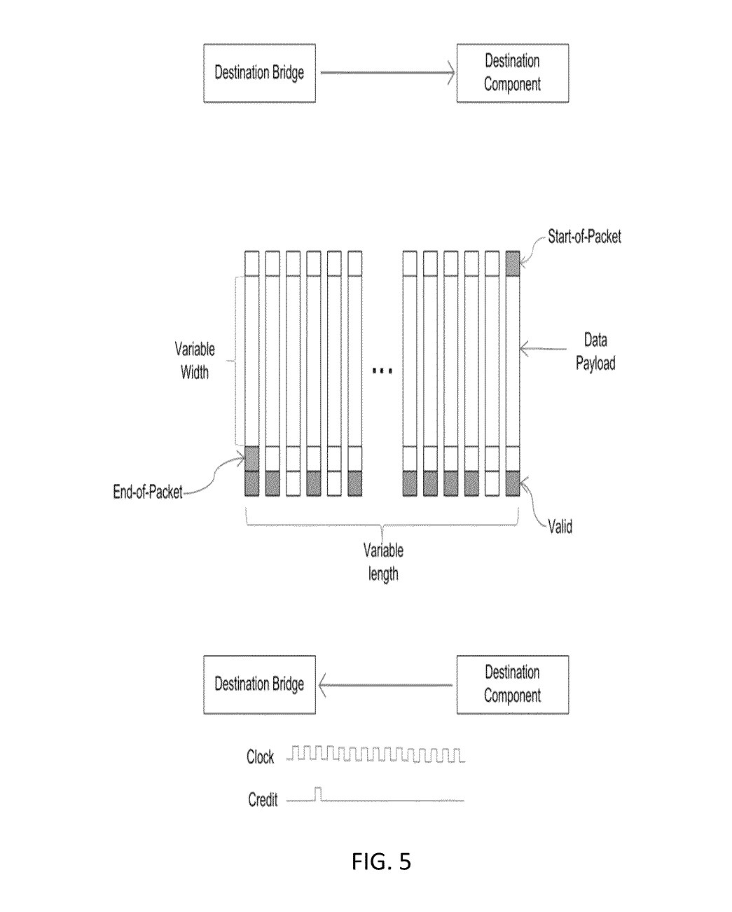

FIG. 5 illustrates the fields used in the proposed bridging protocol on the egress side of the bridge, which is configured to transmit the packet to the destination component, in accordance with an example implementation. Such a bridge on the egress side of a transaction can also be referred to as destination bridge or receiving bridge. Data and/or metadata width of the destination bridge can be different from that of the originating bridge. As illustrated in FIG. 5, the format of the head flit at the destination bridge is changed from the format at the originating bridge, with the head flit now including one bit indicating the start of packet, and packet metadata such as destination node identification field, destination interface identification field, and virtual channel identification fields being stripped away after the corresponding flit is received at the destination bridge. The tail flit includes one bit indicating the end of the packet. In an example, for a short packet of only 1 flit, both the Start-of-Packet and the End-of-Packet bits can be set at the same time. Once a destination bridge receives a packet with the virtual channel identification field intact, the bridge arbitrates based on the destination, virtual channel priorities, and destination component port.

In this way, virtual path and priority of a packet is maintained throughout the NoC and between the originating component and destination component. In an example implementation, all fields provided in data payload by the originating component are preserved and presented to the destination component, wherein, at the destination component, each flit from the destination bridge to the component can be provided only in the presence of a credit. Initial credits within the bridge can be set up based on FIFO depths within the destination component. Any other mechanism can also be implemented for setting up initial credits at the destination bridge and/or the destination component such that when a flit is sent to the destination component, a credit is consumed. As each flit is received and processed, the destination component releases a credit to the bridge.

In an example implementation, within a virtual channel, packets sent from an originating component A are received by an intended destination component B in the same order as they are sent. To preserve all traffic patterns as intended by the originating component, and to prevent deadlocks, the bridge and NoC do not reorder the packets. However, in another example implementation, the packets can be recorded dynamically based on traffic flow and NoC interconnect parameters such as bandwidth, load, network status, width of the channel, among other traffic profile parameters.

Virtual channels are provided within the network to allow priority or isochronous packets to meet latency deadlines. To access a certain virtual channel, the originating component chooses a virtual channel and provides that virtual channel identification field in the head flit of the packet. The originating bridge uses this information and accesses a pre-decided routing table to arbitrate for this packet based on available credits, virtual channel priorities, and destination route. Virtual path from source to destination can be maintained throughout the life of the packet within the NoC. In an example implementation, widths of individual virtual channels are flexible and may be programmed differently from each other as long as each width is less than the programmed width of the destination payload.

According to one example implementation, originating and destination bridges are flexible in terms of how they convert each packet on respective ingress and egress sides. Each bridge may upsize and downsize the packet width to suit the performance of the NoC. For example, the originating NoC interface may upsize or downsize a NoC protocol packet to place it on the physical channel of the NoC interconnect. In another example, a bridge, while processing a packet that is leaving the originating bridge and going into the NoC, may increase the size of the packet two-fold if the width of the NoC physical channel allows the increase, so as to reduce the latency seen within the NoC between originating and destination components.

One example implementation involves mapping a given traffic profile of one or more SoC hosts to the NoC interconnect and configure the NoC hardware by loading the mapping information, wherein the mapping information can include details of performing load balancing between NoC layers by automatically assigning the transactions in the traffic profile to NoC layers and balancing load on various NoC channels based on the bandwidth requirements of the transactions, and in the process also utilizing the available NoC layers and virtual channels for deadlock avoidance and isolation properties of various transactions of the traffic profile. This mapping information can also be forwarded to each router node that the transaction is routed through. Aspects of the present application also include conducting the above mentioned mapping information to enable efficient/optimal and deadlock-free use of the NoC interconnect as part of the NoC interface protocol itself.

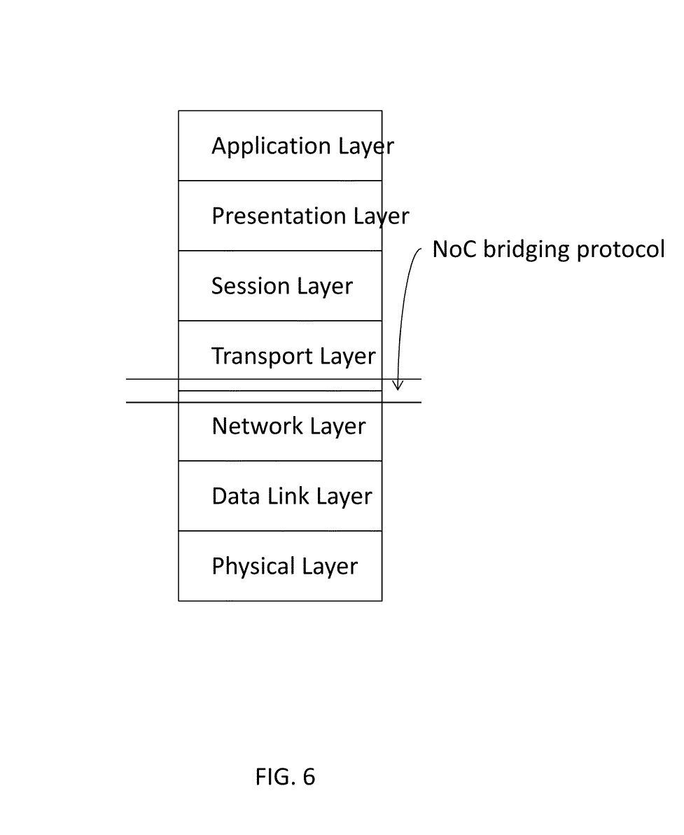

In an OSI (Open Systems Interconnection) model of computer networking, there are seven layers. The layer closest to the electrical interface is the physical layer, while the layer closest to the software, the highest layer, is the application layer. Between the physical layer and the application layer are the data link layer, the network layer, the transport layer, the session layer, and the presentation layer respectively. The proposed protocol of the instant application can be configured to sit between the network and the transport layers. FIG. 6 indicates the position of the proposed NoC protocol, wherein the protocol is capable of converting any transaction in the layers below it as well as any transaction from the Transport layer into the desired NoC packet protocol.

According to one example implementation of the present application, the proposed NoC protocol may not fully support all traffic profiles simultaneously. For instance, from among all the traffic profiles, only certain subsets of traffic profiles may exist in the SoC architecture simultaneously and therefore need to be fully supported in the NoC. The NoC hardware can be designed accordingly for supporting only the valid subsets of co-existing traffic profiles. An example implementation may also support all traffic profiles from the virtual channel allocation perspective, i.e. a virtual channel is assigned for every transaction in all of the traffic profiles, but not in terms of bandwidth. Thus, all the traffic profiles may be mapped to the available NoC layers and virtual channels of the NoC hardware, and bandwidth requirements of transactions of traffic profiles can be fully satisfied if the virtual channel information (virtual channel identifier) and physical channel information (destination node identifier and destination interface identifier) are appropriately provided to the originating bridge.

Further, any other architectural change in configuration of virtual channels, router positions, or NoC interconnect, can be supported by the proposed NoC protocol, wherein the format is first changed by the originating bridge before the packet moves into the NoC and then the format is changed the second time at the destination bridge after the packet is received from the NoC interconnect for onward transmission to the destination component.

Packets are message transport units for intercommunication between various components. A NoC may provide maximum benefit to a system when requests and responses are packetized. Use of packets allows a reduction in hardware cost so that no dedicated connections are required between components. Existing connections can be time shared for packets from different sources going to different destinations. If a section of the NoC is compromised, packets can be automatically re-routed to provide a controlled degradation of the system instead of a deadlock. Hence, packetizing and bridging a chosen component protocol to a NoC may provide an improved interconnect solution.

Packetizing involves identifying a protocol that is flexible and capable of working with the different protocols already in use. The protocol should work for all type of packets, reads, writes, barriers, posted or non-posted, ordered or out-of-order. It should also work for all packet lengths and sizes. Virtual channels inherent in the protocol should be preserved over the NoC, or provided to the components. To provide flexibility and adaptability, bridging protocol may employ wormhole routing, wherein the size of the flit is variable and the number of flits is variable. Additionally, the size of the flit or the number of flits in a packet may be different on the component size of the bridge than it is on the NoC side of the bridge.

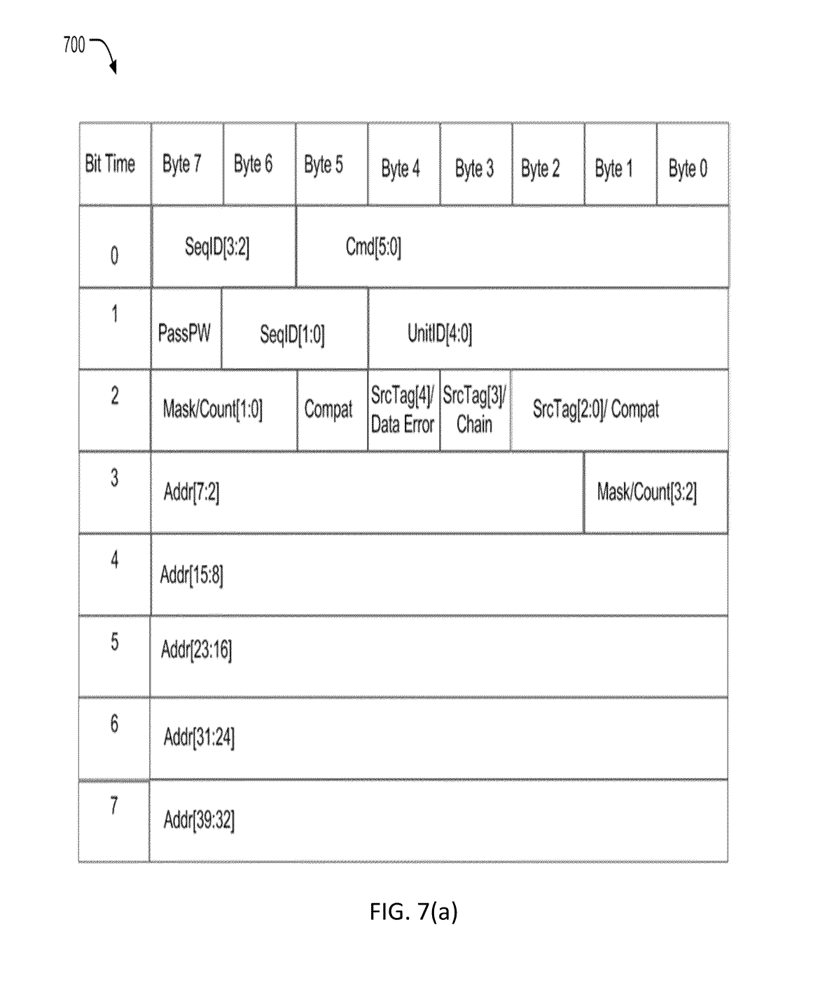

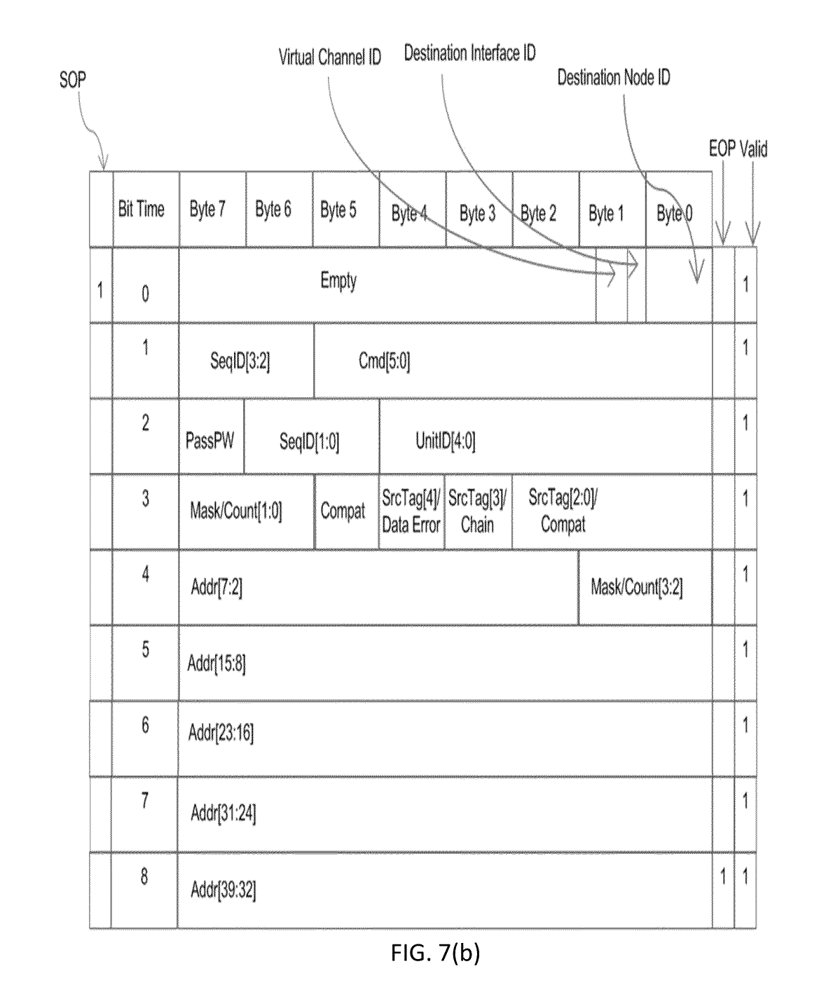

FIG. 7(a) illustrates a related art Hypertransport control packet format 700, which is changed as regards its format based on the proposed NoC protocol, resulting in format as shown in FIG. 7(b). FIG. 7(a) illustrates an example implementation of request control packet format across 7 bit-time and 8 bytes. Multiple other known formats of Hypertransport packets can also be used during actual implementation. Each field of the packet is assumed to relate to their conventional meaning so as to not change the original packet format in manner. For example, Cmd[5:0] is the command field that defines the packet type and SeqID[3:2] is used to tag groups of requests that are issued as part of an ordered sequence by a device and must be strongly ordered within a virtual channel.

All requests between the same source and destination and within the same I/O stream and virtual channel that have matching nonzero SeqID fields must have their ordering maintained. The SeqID value of 0x0 is reserved to mean that a transaction is not part of a sequence. Similarly PassPW indicates that this packet is allowed to pass packets in the posted request channel of the same I/O stream.

FIG. 7(b) shows an example representation of the changed format of the packet in accordance with the proposed NoC protocol. The bit-time has been delayed by 1 bit-time and hence instead of 8 bit-time in the related art packet of FIG. 7(a), the proposed packet format now has 9 bit-time, with the same related art packet now being replicated from bit-time 1-8. Bit-time 0 indicates incorporation of a Start-of-Packet indicator (left-most column), which is set to 1. In addition, bit-time 0 also shows incorporation of byte 0 for indicating destination node identifier, lower bits of byte 1 for indicating destination interface identifier, and higher bits of byte 1 for indicating virtual channel identifier. Similarly, based on the proposed NoC protocol, the End-of-Packet indicator (second column from right) is set at bit-time 8, wherein bit-time 8 indicates the last flit of the packet. A valid bit has been set as 1 for each flit (indicated by each bit-time) on the right-most column, indicating that all the flits are correct. In accordance with the proposed NoC interface protocol, at the destination bridge, the packet format as shown in FIG. 7(b) can be processed to remove the fields of byte 0-2 of the bit-time 0 and then the packet can be pushed to the destination component.

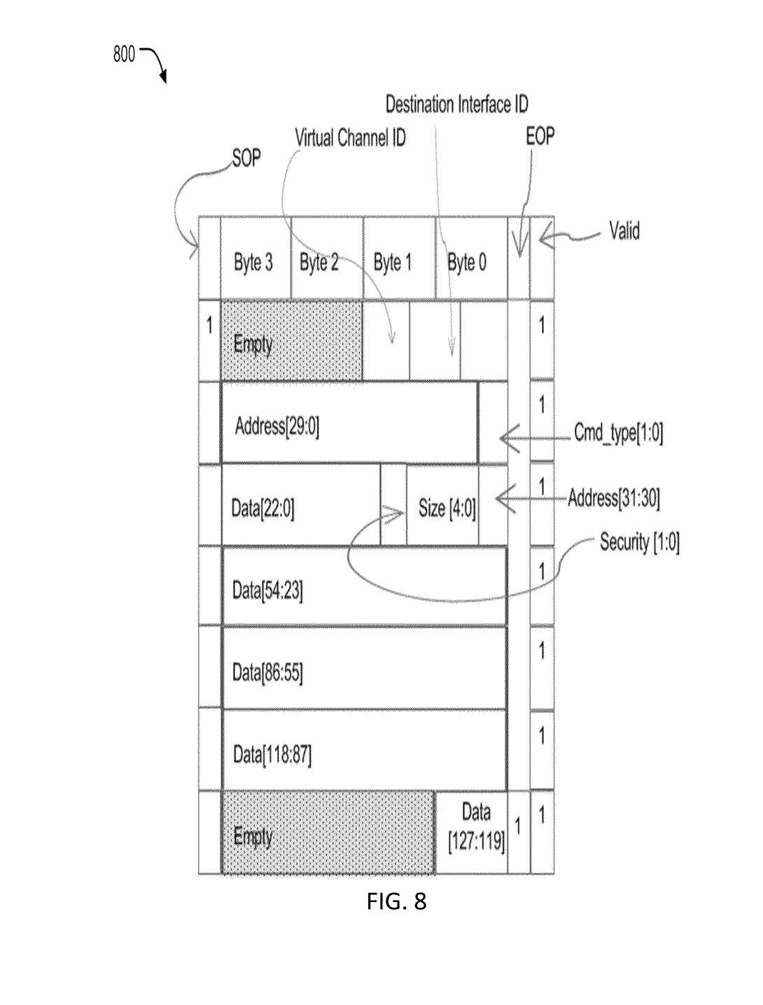

FIG. 8 illustrates packetization of an unpacketized one-cycle custom parallel signal interface based on the proposed NoC protocol in accordance with an example implementation of the present application. In an example implementation, an unpacketized transaction can include multiple interface signals such as:

address[31:0],
data[size-1:0],
size[4:0],
security[1:0], and
command_type[1:0]

Such interface signals as disclosed above can be processed based on the proposed NoC protocol such that the interface signals are first added with additional fields of the protocol including the start of packet (SOP), end of packet (EOP), valid fields and the destination and virtual channel identifiers, which can then be placed in a packet format 800 as illustrated in FIG. 8., Address [29:0] can be placed in the second bit sequence along with the command_type [1:0], data [22:0] can be placed in the third bit sequence along with the size[4:0] and Address [31:30]. Such sequence and placement of interface signals can also be changed if desired by the component protocol. Based on the length of data, NoC protocol properties, component characteristics, NoC bandwidth, and virtual channel attributes such as width, among other factors, data can then be packetized into one or more flits. In an example implementation, only those number of valid flits are initially sent for which the SoC component has credits available, post which, the component can wait for credits from the originating bridge before sending the remaining set of valid flits. Data fields can also be multiplexed based on the NoC interface width, virtual channel attributes, cycle count, among other factors.

In an example implementation, the method of packetization of unpacketized transactions from the originating component can include the steps of identifying interface signals to be packetized, addition of additional fields including start of packet indicator, end of packet indicator, valid packet indicator, destination node identifier, destination interface identifier, and virtual channel identifier to the interface signals, and then breaking down the signals based on the length of each flit (say of 4 bytes), post which the packet can be sent to the destination bridge for onward transmission to the destination component.

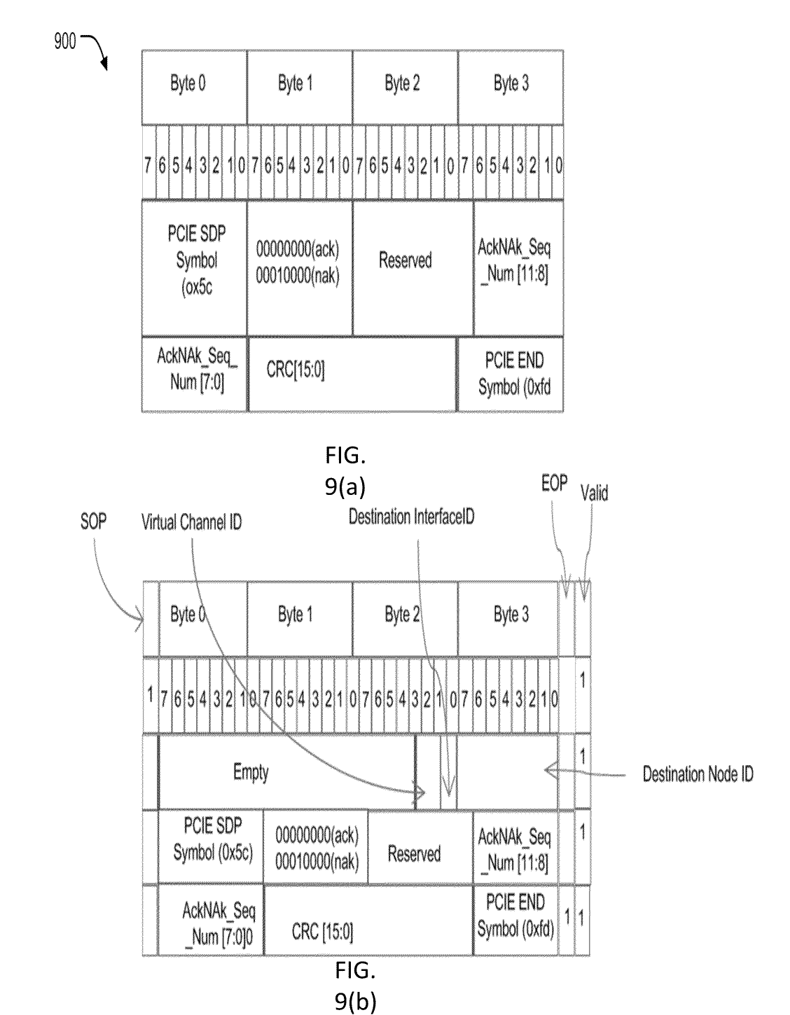

FIG. 9 (a) illustrates a related art Peripheral Component Interconnect Express (PCIE) Data Link Layer (DLL) packet 900. The example DLL packet format of FIG. 9(a) illustrates 4 bytes, each having 8 bits and further presents multiple fields such as sequence number and cyclic redundancy check (CRC), which are added to the transport layer packets (TLP), wherein the CRC protects the contents of the TLP by using a 32-bit LCRC (Link CRC) value. The Data Link Layer calculates the LCRC value based on the TLP received from the Transaction Layer and the applied sequence number. The LCRC calculation utilizes each bit in the packet, including the reserved bits (such as bits 7:4 of byte 0). For the sequence number, the Data Link Layer assigns a 12-bit sequence number to each TLP as it is passed from the transmit side of its transaction layer. Data Link Layer applies the sequence number, along with a 4-bit reserved field to the front of the TLP. On the receiver side, the Data Link Layer receives incoming TLPs from the Physical Layer, checks the sequence number and LCRC, and if they check out properly, the TLP is passed on to the Transaction Layer. Furthermore, if the sequence number does not match the value stored in the receiver's sequence counter, the Data Link Layer discards that TLP. Data Link Layer can also check to see if the TLP is a duplicate, wherein if duplication exists, it schedules an acknowledgement (Ack) DLLP to be sent out for that packet. If the TLP is not a duplicate, it schedules a negative acknowledgement (Nak) DLLP to report a missing TLP.

FIG. 9 (b) illustrates processing of the conventional PCIE Data Link Layer packet based on the proposed NoC Protocol in accordance with an example implementation of the present application. The original DLL packet having the two flits is pushed down by one bit time, and a start of packet field indicator is introduced in the new first flit to indicate the start of the packet. The first flit also incorporates destination node identifier as the byte 3 of the first flit, destination interface identifier as a first part of the byte 2 of the first flit, and virtual channel identifier as a second part of the byte 2 of the first flit. However, it is also possible to change the positioning of the identifiers depending on the desired implementation (e.g., for example, the destination node identifier is part of the byte 0 and destination interface identifier is part of the byte 3). Similar to the format of the transport packet, an end of packet indicate can also be incorporated in the last flit (third flit in the present instance) of the DLL packet. A “valid” indicator, on similar lines, can also be included along with each flit to indicate correctness of the packet. Representation of the modified DLL packet format is merely an example representation and only for illustration purposes and any other format can be used to incorporate additional fields of the proposed NoC protocol.

Although the above-described figures have been demonstrated with respect to implementation of the NoC protocol at the transport and the DLL layer, the protocol can be implemented for changing the packet formats of any other layer (such as physical layer) of the network architecture.

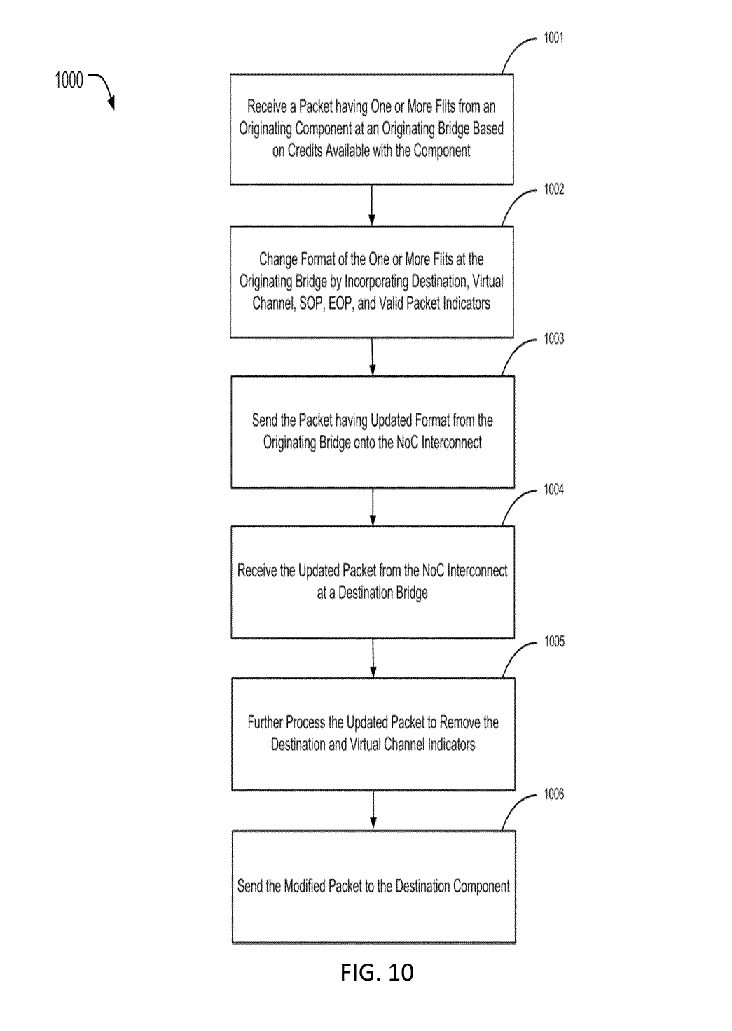

FIG. 10 illustrates a flow diagram 1000 showing transportation of a packet and flits therein between SoC components based on the proposed NoC Protocol in accordance with an example implementation of the present application. At 1001, one or more flits of packet are sent from an originating component (using component compatible protocol) to an originating bridge based on credits available with the component. At 1002, the originating bridge adds “start of packet”, “end of packet”, and valid fields in each flit of the packet and further introduces destination node identifier, destination interface identifier, and virtual channel identifier in the first flit of the packet. At 1003, the originating bridge sends the newly formatted packet having flits for onward transmission onto the NoC interconnect using one or more routers/nodes. At 1004, a destination bridge receives the packet. At 1005, each flit of the received packet is processed such that the destination node identifier, destination interface identifier, and virtual channel identifier fields are removed from the first flit. Further processing of the flits and payload data therein may be conducted based on the additional “start of packet”, “end of packet”, and valid fields. At 1006, the processed flits that are compatible with the destination component protocol may be sent from the destination bridge to the destination component.

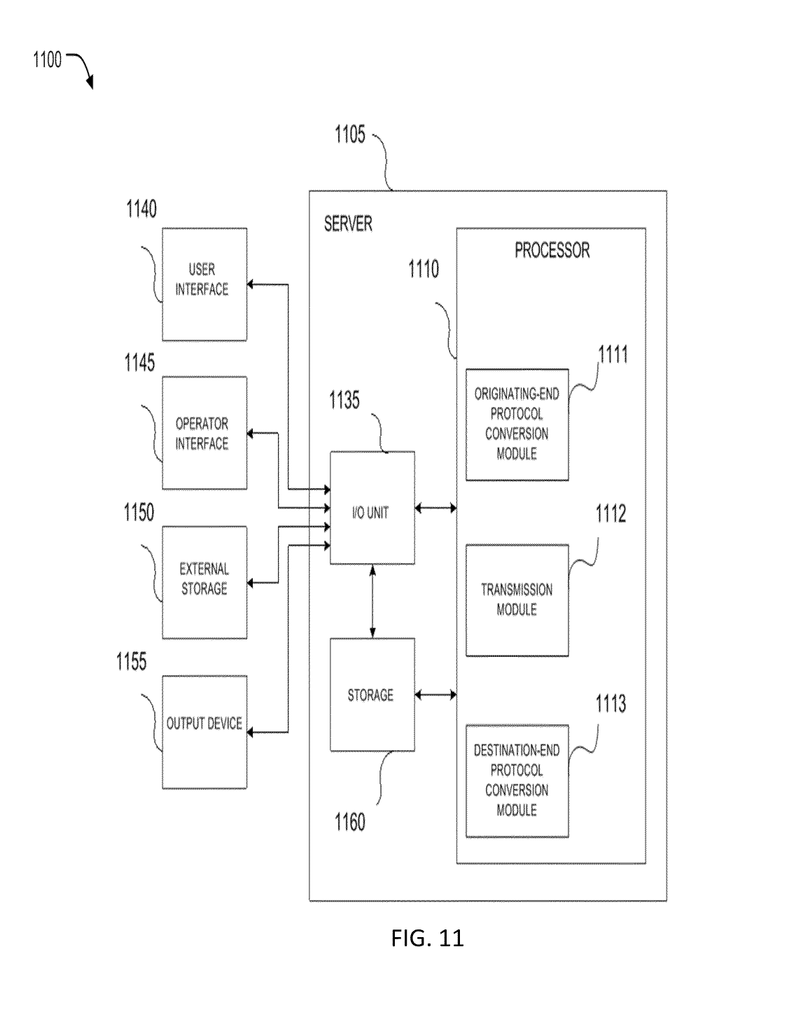

FIG. 11 illustrates an example computer system 1100 on which example implementations may be implemented. The computer system 1100 includes a server 1105 which may involve an I/O unit 1135, storage 1160, and a processor 1110 operable to execute one or more units as known to one of skill in the art. The term “computer-readable medium” as used herein refers to any medium that participates in providing instructions to processor 1110 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include carrier waves. The I/O unit processes input from user interfaces 1140 and operator interfaces 1145 which may utilize input devices such as a keyboard, mouse, touch device, or verbal command.

The server 1105 may also be connected to an external storage 1150, which can contain removable storage such as a portable hard drive, optical media (CD or DVD), disk media or any other medium from which a computer can read executable code. The server may also be connected an output device 1155, such as a display to output data and other information to a user, as well as request additional information from a user. The connections from the server 1105 to the user interface 1140, the operator interface 1145, the external storage 1150, and the output device 1155 may via wireless protocols, such as the 802.11 standards, Bluetooth® or cellular protocols, or via physical transmission media, such as cables or fiber optics. The output device 1055 may therefore further act as an input device for interacting with a user.

The processor 1110 may execute one or more modules including an originating-end protocol conversion module 1111, a transmission module 1112, and a destination-end protocol conversion module 1113. The originating-end protocol conversion module 1111 may be configured to send a packet from an originating component to an originating bridge, at which instant, format of the packet, including one or more flits, may be modified based on the proposed NoC protocol by inclusion of start of packet, end of packet, and flit validity indicators. In additional further information about the destination node, destination interface, and virtual channel may be added to the first flit of each packet to help the NoC interconnect transmit the packet to the right destination bridge/component using the intended virtual channel.

According to one example implementation, the transmission module 1112 may be configured to transmit the packet to the destination bridge using the virtual channel indicated by the originating bridge. According to another example implementation, width and length of a specific packet of the NoC protocol may be modified at the output of the originating NoC hardware bridge (originating bridge) for performance or power, keeping the NoC protocol the same. Similarly, in another example implementation, width and length of a specific packet of the NoC protocol may be modified at the output of a destination NoC hardware bridge component (destination bridge) for performance or power or destination host capabilities, keeping the NoC protocol the same.

According to another example implementation, the destination-end protocol conversion module 1113 may be configured to enable the destination bridge to convert the received packet format and making it compatible and interoperative with the destination component protocol. In an instance, the destination bridge may be configured to remove the identifiers of destination node, destination interface, and virtual channel from the first flit of the packet and then transmit the packet to the destination component. As the system interface protocols of each SoC component may be different, it is the mandate of the destination-end protocol conversion module 1113 to configure the destination bridge such that the bridge is aware of the system protocol of the destination component and accordingly change the format of the received flits and transmit the same to the component.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example implementations, the steps carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A method for communicating data between System on Chip (SoC) component through an Network on Chip (NoC) interconnect, the method comprising:
converting a format of the data from a source SoC interface protocol format to a NoC interface protocol format;
converting the format of the data from the NoC interface protocol format to a destination SoC interface protocol format;
sending the data in the destination SoC interface protocol format to the SoC component.

2. The method of claim 1, wherein the converting the format of the data from the source SoC interface protocol format to the NoC interface protocol format is conducted by an originating bridge.

3. The method of claim 2, wherein the data comprises one or more flits and the originating bridge incorporates one or more of a start of packet (SOP), an end of packet (EOP), and a valid packet field in the one or more flits.

4. The method of claim 2, wherein the data has one or more flits and the originating bridge incorporates one or more of a destination node identifier, a destination interface identifier, and a virtual channel identifier in at least one flit of the data.

5. The method of claim 4, wherein the at least one flit is a first flit of the data.

6. The method of claim 1, wherein the converting the data from the NoC interface protocol format to the destination SoC interface protocol format is conducted by a destination bridge.

7. The method of claim 6, further comprising removing one or more of a destination node identifier, a destination interface identifier, and a virtual channel from the data before sending the data to the destination SoC component.

8. The method of claim 1, wherein the data is unpacketized, and wherein the unpacketized data is packetized based on the NoC interface protocol format before conversion to the destination SoC interface protocol format.

9. The method of claim 1, wherein the source SoC interface protocol format and the destination SoC interface protocol format have different parameters comprising at least one of size, width, sequence, and length.

10. A computer readable storage medium storing instructions for communicating data between System on Chip (SoC) component through an Network on Chip (NoC) interconnect, the instructions comprising:
converting a format of the data from a source SoC interface protocol format to a NoC interface protocol format;
converting the format of the data from the NoC interface protocol format to a destination SoC interface protocol format; and
sending the data in the destination SoC interface protocol format to the SoC component.

11. The computer readable storage medium of claim 10, wherein the instructions further comprise utilizing an originating bridge for converting the format of the data from the source SoC interface protocol format to the NoC interface protocol format.

12. The computer readable storage medium of claim 11, wherein the data comprises one or more flits and wherein the utilizing the originating bridge comprises incorporating one or more of a start of packet (SOP), an end of packet (EOP), and a valid packet field in the one or more flits.

13. The computer readable storage medium of claim 11, wherein the data has one or more flits and wherein the utilizing the originating bridge comprises incorporating one or more of a destination node identifier, a destination interface identifier, and a virtual channel identifier in at least one flit of the data.

14. The computer readable storage medium of claim 13, wherein the at least one flit is a first flit of the data.

15. The computer readable storage medium of claim 10, wherein the instructions further comprise utilizing a destination bridge for converting the data from the NoC interface protocol format to the destination SoC interface protocol format.

16. The computer readable storage medium of claim 15, wherein the instructions further comprise removing one or more of a destination node identifier, a destination interface identifier, and a virtual channel from the data before sending the data to the destination SoC component.

17. The computer readable storage medium of claim 10, wherein the data is unpacketized, and wherein the instructions further comprise packetizing the unpacketized data based on the NoC interface protocol format before conversion to the destination SoC interface protocol format.

18. The computer readable storage medium of claim 10, wherein the source SoC interface protocol format and the destination SoC interface protocol format have different parameters comprising at least one of size, width, sequence, and length.
